(19) United States
(12) Patent Application Publication
(10) Pub. No.: US 2013/0282425 A1
(43) Pub. Date: Oct. 24, 2013

(54) Intelligent Whistleblower Support System

(71) Applicant: Ying Zeng, Fremont, CA (US)

(72) Inventor: Ying Zeng, Fremont, CA (US)

(73) Assignee: SA[ AG, Walldorf (DE)

(21) Appl. No.: 13/453,171

(22) Filed: Apr. 23, 2012

(51) Int. Cl. G06Q 10/06

(52) U.S. Cl. 705/7.27

(57) ABSTRACT

A system for anonymously receiving information relating to suspected dishonest or illegal activity relating to an organization includes several interfaces that facilitate the anonymity. An automated analyzer analyses the received information to identify relevant governing documents (e.g., laws, regulations, etc.) and relevant personnel. A remediation workflow may then be generated based on the identified relevant information to address the report of suspected dishonest or illegal activity.

### BACKGROUND

Unless otherwise indicated herein, the approaches described in this section are not prior art to the claims in this application and are not admitted to be prior art by inclusion in this section.

It is becoming increasingly important to encourage and facilitate the reporting of irregular or questionable activities occurring in an organization, such as a business. Recent bad behavior in some companies have created the need for heightened requirements in the areas of corporate governance, financial disclosures, and accountability for fraud. Indeed, some regulations include whistle-blower protection clauses. Ensuring anonymity is important to encourage whistle blowing. It is also important to be able to intelligently process reports received from whistleblowers. Since received reports are likely to be anonymous, how well the report is handled is dependent largely on the quality of the information in the report.

### BRIEF DESCRIPTION OF THE DRAWINGS

FIG. 1 shows a block diagram of an embodiment of the present disclosure.

FIG. 2 illustrates a workflow in accordance with disclosed embodiments.

FIG. 3 shows a system diagram in accordance with the present disclosure.

### DETAILED DESCRIPTION

In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

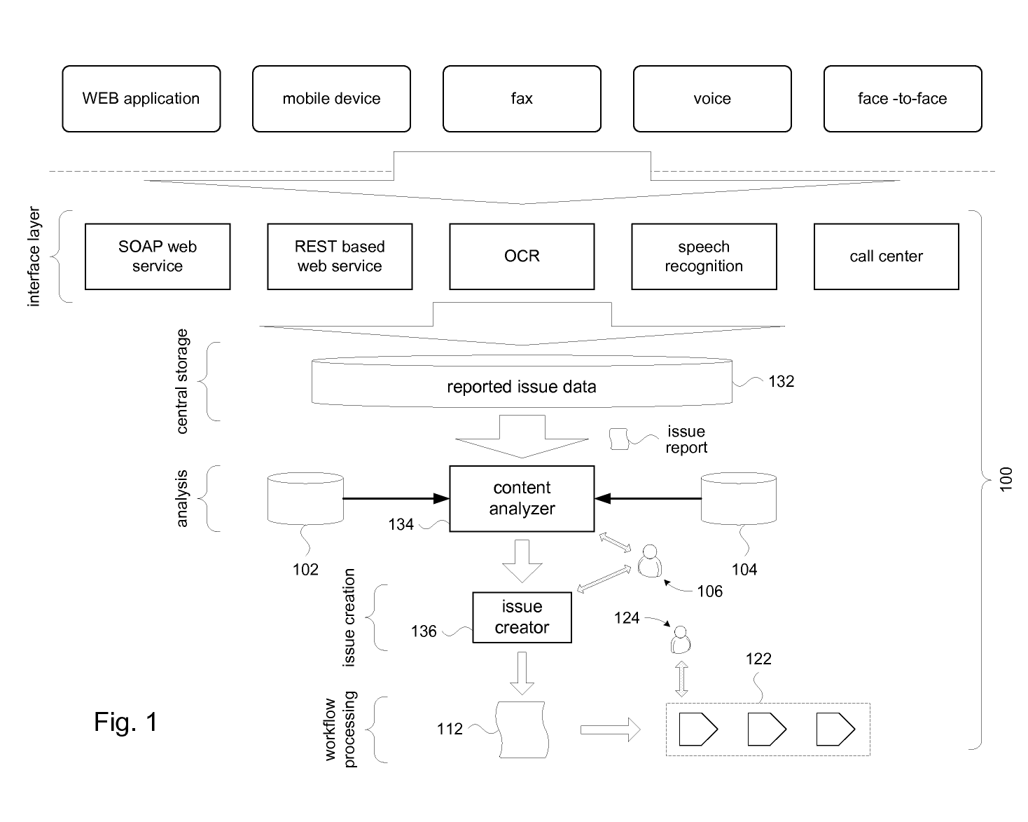

A whistle blower is a person who reports about suspected dishonest or illegal activities (“misconduct”) occurring in an organization, such as in a government department, a company, and the like. The misconduct may be defined in many ways; for example, a violation of a law, rule, regulation, etc., and/or a direct threat to public interest, such as fraud, health/safety violations, corruption, and so on. FIG. 1 shows a system 100 in accordance with embodiments of the present disclosure to facilitate a whistle blower's effort in making a report and the processing of an issue report. To support whistle blowers, the organization (e.g., a business) may provide several different channels so the whistle blower can report their issues conveniently and anonymously. These reported issues may be stored centrally as “issue reports”.

Embodiments of the architecture disclosed herein support different channels for the whistle blower (“user”) to report issues. The user may approach the system 100 via a Web application from their computer (desktop, laptop, or other mobile device). For example, the user may navigate, using a suitable browser, to a web site that is designed to receive input from the user relating to the misconduct at issue. The web site may present a text entry box, where the user simply types in whatever information they wish to type in. The web site may include a hierarchy of pages and data input fields to capture relevant information about the misconduct from the user.

The user may access the system 100 via mobile device that is executing a whistle blower mobile application (“app”) that is specialized for such reporting. The user may submit an issue report by faxing a document that sets forth details of the misconduct. The user may make a telephone call into a call center to report the misconduct. The user may speak to a live operator, who can obtain the information. The user may be presented with an automated system and simply speak the details of the misconduct to the automated system. The user may have a face-to-face meeting with a person (e.g., a human resources person in a company). In cases where the user is communicating with another person, the person taking down the information may fill out a form (paper or electronic) and submit a completed form to the system 100. Some channels may easily provide adequate anonymity of the user (e.g., web interface); however, it is understood that other channels (e.g., face-to-face meetings) may need to provide suitable measures to ensure anonymity of the user and other considerations to encourage their reporting of issues.

The interface layer of system 100 may include a web-based interface, such as a Simple Object Access Protocol (SOAP) based web service, or a Representational State Transfer (REST) based web service. The reported issues may then be posted to the system via the web service interface. The interface layer may include optical character recognition (OCR) capability. For example, if the issue report is presented as a fax document, OCR processing may be employed when the fax is received to convert the material in the fax document to textual data that can be stored. The interface layer may include speech recognition capability to convert a user's recorded spoken details to textual data that can be stored.

The interface layer may include a call center, which may be manned by call center agents or may be an automated system. A call center agent may take notes while speaking with the user, and then submit a written report to the system; e.g., the written report may be scanned by OCR processing to produce textual data that can be stored. Speech recognition may be invoked to convert any recordings with the user to produce textual data that can be stored. When the user conducts a face-to-face meeting with someone to report the misconduct, any handwritten notes may be submitted to OCR processing to generate textual data that can be stored.

The system 100 may include a central storage system 132 to store the data provided by the user. For example, a web based service (e.g., SOAP, REST) produces data that can be stored directly in the central storage system 132. Likewise, data from an app executing on a mobile device can be stored directly in the central storage system 132. By contrast a received fax document, for example, may be scanned and stored as an image. OCR processing can be performed to produce textual data representative of the content in the document which can then be stored in the central storage system 132. Similarly, voice recordings may be processed through speech recognition to produce textual data that can then be stored in the central storage system 132.

In some embodiments, the issue report may be identified by a generic identifier. The identifier may include information to help identify the issue, such as the date on which the issue report was opened and so on. However, in order to ensure anonymity, the issue report should not include any information that might identify the user.

An automated process called the content analyzer 134 may retrieve information for a given issue report that is stored in the central storage system 132. The content analyzer 134 may be connected to a personnel database 102 and to a knowledge base 104. As will be explained in more detail below, the content analyzer 134 may generate a collection of relevant information based on the information contained in the issue report. In some embodiments, a handler 106 may be assigned to the content analysis process to provide decision-making on matters that the content analyzer 134 may not be able to resolve and in general to handle matters that an automated process may not be able to adequately handle.

The content analyzer 134 may send the collection of relevant information to an issue creator 136 to identify one or more issues that need to be resolved in order to address the misconduct that is being reported in the issue report. The issue creator 136 may produce an issue data object 112 which organizes the collection of relevant information and identified issues in a suitable data structure. In some embodiments, the issue data object 112 may include a remediation workflow 122. The issue data object 112 may also include an issue owner 124 who “owns” the remediation workflow 122. The handler 106 may be involved in the issue creation process to resolve matters that may not be adequately resolved by an automated process such as the issue creator 136.

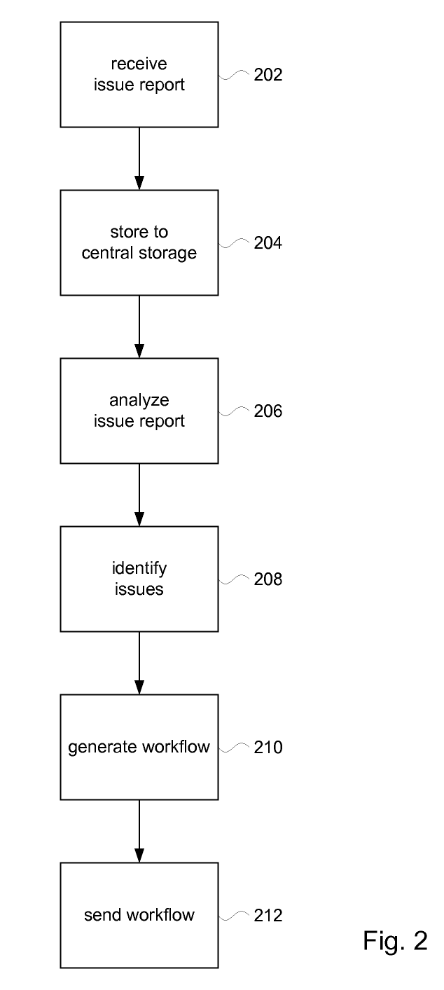

Referring to FIG. 2, processing in accordance with the present disclosure is shown. In a step 202, a user (e.g., a whistle blower) may access the system 100 by any one of several channels to report (in an issue report) possible misconduct in the organization. Access may include, but is not limited to, a web interface (e.g., via a web site, or a mobile device running a suitable app, and so on), by faxing a documentation of the user's observations and other information in support of the reported misconduct, by making a call to a call center, by having a face-to-face meeting with someone, and so on.

In a step 204, the received issue report may then be stored in the central storage system 132. As explained above, this step may include performing OCR processing or speech recognition processing to produce textual data that is suitable for storage. In addition, raw data (e.g., received fax, scanned document, voice recording, etc) may be stored in the central storage system 132 along with the converted textual data. The raw data may include non-textual information that may inform the subsequent analysis. For example, a received fax may include some drawings or other notation that have no corresponding textual data. A voice recording may include nuances in the speech (e.g., stress in the voice, background noise) that would not be picked up during speech recognition, but might be relevant to the subsequent analysis.

In a step 206, the issue report may be retrieved from the central storage system 132 along with any associated raw data (e.g., scanned document, voice recording, etc.), and an analysis may be initiated by the content analyzer 134 to identify information that may be relevant to the misconduct being reported. In an embodiment, the content analyzer 134 may analyze the content in the issue report based on key words. In other embodiments, the content analyzer 134 may be an expert system, a rule-based analytical system, and so on.

In some embodiments, the knowledge base 104 may be preconfigured with a keywords which are mapped to corresponding laws, rules, regulations, policies, and so on (collectively referred to herein as “governing information”) which govern the activity of the organization. The governing information may originate from the government (city, state, etc.), or may be from the by-laws and policies of the organization, and so on. A collection of relevant governing information may be identified from this larger pool of governing information based on key words appearing in the issue report. For example, the phrase “excessive gifts” occurring in the issue report may cause the content analyzer 134 to identify governing information relating to the giving of gifts that are applicable to the organization. The following additional examples of key word to governing information mapping ser provided merely for the purpose of further illustrating this aspect of the present disclosure:

“travel expenses”→travel policy

“bribery”→Code of Conduct

“fraud in financial reporting”→Sarbanes-Oxley (SOX) compliance

<name>→find information related to this person

The collection of relevant governing information may include links or references to related documents, organizational information, and so on.

Resolution of the reported misconduct may require personnel within (and possibly outside of) the organization. Accordingly, the personnel database 102 may include various members of the organization, such as high level decision makers or managers. Such personnel may be mapped or otherwise associated with key words that may appear in the issue report. For example, key words such as “salesman” and “excessive gifts” occurring in the issue report may trigger an association with a sales manager, since the issue may involve a salesman giving excessive gifts to a customer and the sales manager may be in a position to take appropriate corrective action. The content analyzer 134 may identify a collection of such personnel in the organization who may be relevant to resolving the misconduct that is reported in the issue report based on the content of the issue report.

The content analyzer 134 may identify a person or persons who may be involved in the suspected dishonest or illegal activity. For example, keywords may trigger the content analyzer 134 to identify text following such a keyword or text in the vicinity of the keyword and treat the text as names of people. The content analyzer 134 may search the organization's personnel database to attempt to a match. Corresponding personnel data may then be collected for any matches that are found.

The content analyzer 134 may identify a handler 106 to facilitate the analysis. A function of the handler 106 may be to enhance the processing of the content analyzer 134 in its function of collecting information that can be relevant to resolving or otherwise addressing the misconduct being reported in the issue report. Another function of the handler 106 may be to perform a “sanity check” on the results analysis made by the content analyzer 134 to avoid any obvious or gross errors that may result from the automated processing of the content analyzer 134. Accordingly, in some embodiments, the knowledge base 104 may include a list of personnel from the organization who are responsible for this task. Key words in the issue report may be used to select an appropriate handler. For example, the phrase “excessive travel expense” occurring in the issue report may cause the content analyzer 134 to select a handler from the accounting department.

In some embodiments, the content analyzer 134 may identify an issue owner 124 from among the personnel in the personnel database 102. The personnel may comprise people within the organization. In some embodiments, the personnel database 102 may include personnel who are outside of the organization. For example, the personnel database 102 may include contact persons in various governmental (e.g., state level, federal level) agencies that are responsible for regulating or otherwise monitoring the organization's activities. The issue owner 124 may be a contact person in one of the governmental agencies.

In a step 208, the issue creator 136 may use the collection of relevant information (e.g., relevant governing information, organization's personnel, etc.) obtained in step 206 to identify one or more issues arising from the misconduct that is reported in the issue report. In some embodiments, the issue creator 136 may automatically identify and generate an initial proposal of issues (“issue proposal”). The issue proposal may then be reviewed by the handler 106, who may then make changes or refinements to the proposed issues. The handler 106 may assess the propriety of the issue owner 124 identified by the issue creator 136. The handler 106 may assign a more suitable issue owner 124 to the reviewed/revise issue proposal. The handler 106 may then trigger generation of an issue data object 112 to contain the data comprising the issue proposal. The issue data object 112 provides a structured repository for all the information collected in the prior steps, such as the collection of relevant governing information, links or references to documents, a collection of relevant personnel, and so on. The issue data object 112 allows the information to be programmatically monitored and managed during the course of resolving the issue(s) identified in the issue report.

In a step 210, the issue data object 112 may be used to trigger a remediation workflow 122. In some embodiments, remediation workflow templates are predefined. The remediation workflow templates can be configured differently depending on the type of policy that is being violated. After the issue data object 112 is created from the issue report, an instance of the remediation workflow will go through the route defined in the remediation workflow template and be sent to recipients defined in the remediation workflow template (handlers or issue owners or people executing remediation). For example, the remediation workflow 122 may be communicated in a step 212 to the issue owner 124; for example, by email over the organization's internal network.

The remediation workflow 122 may then be executed by the issue owner 124. The specific execution steps will depend on the specifics of the remediation workflow 122. For example, the issue owner 124 may assign different segments of the remediation workflow 122 to different people within their department. The remediation workflow 122 may include checklists, action plans, corrective measures, and so on.

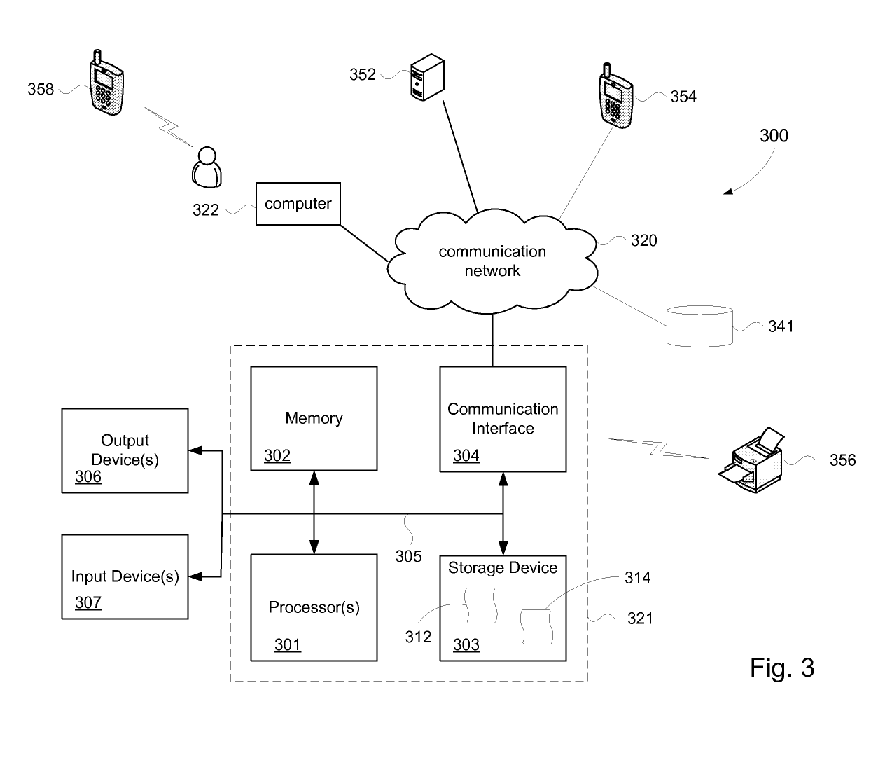

FIG. 3 is a block diagram of system 300 which may represent a particular embodiment of system 100 shown in FIG. 1. The system 300 may include computers 321 and 322 connected to a suitable communication network 320, such as the Internet. Each computer (e.g., computer 321) may be configured as a general purpose computing apparatus and may execute program code to perform any of the functions described herein.

Computer 321 may include, among its components, a processor component 301 (comprising one or more processing units) operatively coupled to a communication interface 304, a data storage device 303, one or more input devices 307, one or more output devices 306, and a memory 302. The communication interface 304 may facilitate communication on the communication network 320. Computer 321 may include suitable input device(s) 307 such as a keyboard, a keypad, a mouse, and so on. Output device(s) 306 may include, for example, a display (e.g., a display screen), a speaker, a printer, and so on.

The data storage device 303 may comprise any appropriate persistent storage device, including combinations of magnetic storage devices (e.g., magnetic tape, hard disk drives and flash memory), optical storage devices, Read Only Memory (ROM) devices, etc., while memory 302 may comprise Random Access Memory (RAM). The data storage device 303 may store program code 312 which may be executed by the processor component 301 to cause the computer to perform any one or more of the processes and methods described herein. In embodiments, for example, the program code 312 may cause the computer to execute steps such as shown in FIG. 2.

The data storage device 303 may store various data structures 314 such as instances of the issue data object 112. The data storage device 303 may also store data and other program code for providing additional functionality and/or which are necessary for operation thereof, such as device drivers, operating system files, etc.

System 300 may include a storage device 341, such as a data server. The storage device 341 may constitute the central storage system shown in FIG. 1. The storage device 341 may also provide storage for the supporting databases such as the personnel database 102 and the knowledge database 104.

The user may submit their issue report using a personal computer 352 or a mobile device 354 to access computer 321 via a suitable web interface on computer 321. The user may send in a fax to computer 321 using a fax machine 356. The user may call into the call center with their mobile phone 356.

System 300 may include computer 322 configured to serve as a call center for receiving calls from users who wish to report suspected misconduct. The call center may be manned with agents, or may be an automated call center.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. It will be appreciated that embodiments are not limited to any specific combination of hardware and software. Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

### ADVANTAGES AND TECHNICAL EFFECT

The present disclosure describes a system and method to intelligently process reports of suspected dishonest or illegal activity within an organization. Several interfaces allow a whistleblower user to conveniently and anonymously provide information to the system. The system is automated to gather as much relevant information as possible using the information provided by the user. The automation alleviates much of the initial processing effort and provides a uniform process for handling reports of suspected dishonest or illegal activity. A handler may participate by reviewing an output (issue proposal) of the automated process to make changes and refinements to the issue proposal. Embodiments in accordance with the present disclosure therefore provides a secure and anonymous reporting environment to promote the reporting of suspected dishonest or illegal conduct, and provides uniform and consistent analysis of the reported issues.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A computer implemented method for reporting on activity in an organization comprising:
receiving information relating to a suspicion of dishonest or illegal activity involving the organization;
storing the received information in a data store;
identifying, based on data comprising the received information, a collection of governing information from among a plurality of governing information that govern activities conducted by the organization, the collection of governing information relating to the suspected dishonest or illegal activity;
identifying, based on data comprising the received information, a collection of one or more actors that are related to the suspected dishonest or illegal activity; and
generating a remediation workflow based at least on the collection of governing information and the collection of one or more actors, the remediation workflow comprising a plurality of activities relating to resolution of the suspected dishonest or illegal activity.

2. The computer implemented method of claim 1 wherein identifying a collection of governing information comprises identifying predefined keywords in the received information, each keyword being associated with one or more of the governing information.

3. The computer implemented method of claim 1 wherein information that identifies a sender of the received information is omitted from the received information.

4. The computer implemented method of claim 1 wherein the collection of one or more actors includes personnel of the organization.

5. The computer implemented method of claim 1 wherein the information is received using a WEB services interface, or as an electronic document, or as a fax document, or as a voice recording.

6. The computer implemented method of claim 5 further comprising performing optical character recognition on the fax document.

7. The computer implemented method of claim 5 further comprising performing speech recognition on the voice recording.

8. The computer implemented method of claim 1 further comprising identifying a handler to review and revise the collection of governing information.

9. The computer implemented method of claim 1 wherein generating a remediation workflow comprises selecting from among a plurality of predetermined workflows.

10. A system for reporting on activity in an organization comprising:
a computer;
a storage system; and
computer executable program code which, when executed by the computer, causes the computer to:
receive information relating to a suspicion of dishonest or illegal activity involving the organization;
store the received information in the storage system;
identify, based on data comprising the received information, a collection of governing information from among a plurality of governing information that govern activities conducted by the organization, the collection of governing information relating to the suspected dishonest or illegal activity;
identify, based on data comprising the received information, a collection of one or more actors that are related to the suspected dishonest or illegal activity; and
generate a remediation workflow based at least on the collection of governing information and the collection of one or more actors, the remediation workflow comprising a plurality of activities relating to resolution of the suspected dishonest or illegal activity.

11. The system of claim 10 further comprising a data store of keywords, each keyword associated with one or more of the governing information, wherein the collection of governing information comprises the governing information associated with one or more keywords contained in the received information.

12. The system of claim 10 wherein execution of the computer executable program code further causes the computer to identify a handler to review and revise the collection of governing information.

13. The system of claim 10 wherein execution of the computer executable program code further causes the computer to identify an issue owner and send the remediation workflow to the issue owner.

14. The system of claim 13 wherein the issue owner is identified from among a plurality of personnel in the organization.

15. The system of claim 10 wherein execution of the computer executable program code further causes the computer to provide a WEB services interface, wherein the received information is received from the WEB services interface.

16. The system of claim 10 further comprising a call center having agents to receive the information or an automated system to receive the information as recorded incoming calls.

17. The system of claim 10 further comprising a fax device to receive the information in the form of a fax document.

18. The system of claim 17 wherein execution of the computer executable program code further causes the computer to perform OCR processing on a received fax document.

19. A method for reporting on activity in an organization comprising:
using a WEB services interface to receive information relating to a suspicion of dishonest or illegal activity involving an organization;
storing the received information in a data storage system;
generating a collection of governing documents from among a plurality of governing documents that govern activities conducted by the organization, including:
identifying one or more predefined keywords in the received information; and
for each predefined keyword identified in the received information, producing a list of one or more governing documents that are associated with the predefined keyword,
wherein the collection of governing documents comprises a list of the governing documents produced for all predefined keywords identified in the received information;
identifying, based on data comprising the received information, a collection of one or more actors that are related to the suspected dishonest or illegal activity; and
generating a remediation workflow based at least on the collection of governing information and the collection of one or more actors, the remediation workflow comprising a plurality of activities relating to resolution of the suspected dishonest or illegal activity.

20. The method of claim 19 further comprising receiving information relating to an allegation of dishonest or illegal activity involving the organization via a fax or at a call center.
